(19) United States
(12) Patent Application Publication
(10) Pub. No.: US 2025/0205909 A1
(43) Pub. Date: Jun. 26, 2025

(54) GRIPPING TOOL AND GRIPPING DEVICE

(71) Applicant: Mitsubishi Electric Corporation, Tokyo (JP)

(72) Inventors: Rin ITO, Tokyo (JP); Minas LIAROKAPIS, Auckland (NZ); Joao Pedro Sansao BUZZATTO, Auckland (NZ); Junbang LIANG, Auckland (NZ); Mojtaba SHAHMOHAMMADI, Auckland (NZ); Toshisada MARIYAMA, Tokyo (JP); Saori MATSUNAGA, Tokyo (JP)

(73) Assignee: Mitsubishi Electric Corporation, Tokyo (JP)

(21) Appl. No.: 19/079,005

(22) Filed: Mar. 13, 2025

Related U.S. Application Data
(63) Continuation of application No. PCT/JP2022/038496, filed on Oct. 17, 2022.

(51) Int. Cl. B25J 15/12; B25J 9/10; B25J 19/00

(52) U.S. Cl. CPC B25J 15/12; B25J 9/1075; B25J 19/007

(57) ABSTRACT

The gripping tool according to the disclosed technology is a gripping tool to grip a gripping target based on a principle of driving kirigami, the gripping tool including, gripping portion being sheet-shaped and covering the gripping target, tendon portion having string portion inside and pulling the gripping portion from both sides, pull portion being connected to the tendon portion and functioning as a pulley, fingertips portion being attached to the gripping portion by socket, wherein, the gripping portion is a two-layer structure, the two-layer being a layer of covering layer and core layer.

### CROSS REFERENCE TO RELATED APPLICATIONS

This application is a Continuation of PCT International Application No. PCT/JP2022/038496 filed on Oct. 17, 2022, all of which is hereby expressly incorporated by reference into the present application.

### TECHNICAL FIELD

The present disclosure relates to gripping tools and gripping devices.

### BACKGROUND ART

In the technical field of robot hands for gripping targets, gripping tools being achieved from the inspiration of origami are known. For example, “Origami Hand”, a gripping tool made only of paper, is known. Because “Origami Hand” is made only of paper, it is expected to be applied in the medical field and the food field where, in both fields, tools are supposed be disposable for hygiene reasons.

Patent Document 1 discloses a gripping device being inspired by origami “flapping birds” and operating on the same principle. FIG. 1 is an explanatory diagram showing the flapping bird made by origami. As shown in FIG. 1, when the neck part and the tail part of the “flapping bird” are held with both hands and pulled outward, the left and right wings are closed as if they were fluttering. The gripping device according to Patent Document 1 is achieved by making slots in a sheet of flexible material, and by pulling two actuation tabs corresponding to the neck portion and the tail portion, the upper and lower jaw portions corresponding to the left and right wings get close to each other, thereby enabling an object to be grasped.

### CITATION LIST

### Patent Literature

### [Patent Document 1]

WO 2020/237058 A1

### SUMMARY OF INVENTION

### Technical Problem

In Patent Document 1, the concept of making the gripping device from a sheet of flexible material is an excellent idea, but it is overly focused on this concept, and the gripping device has some drawbacks practically. As one of the drawbacks, as can be seen from FIG. 6B of Patent Document 1, there is a problem that the actuating tabs cannot be strongly pulled because the shear stress is concentrated in the slot when the actuating tabs are pulled.

An object of the disclosed technology is to improve the gripping device according to the prior art and provide a practical gripping tool solving the above problem.

### Solution To Problem

The gripping tool according to the disclosed technology is a gripping tool to grip a gripping target on the basis of a principle of driving kirigami, the gripping tool including: a gripping portion being sheet-shaped and configured to cover the gripping target; tendon portions each having a string portion inside and transmitting a force pulling the gripping portion from both sides; pull portions each being connected to the tendon portions and functioning as a pulley; and fingertips portion each being attachable to and detachable from the gripping portion via a socket, wherein the gripping portion has a two-layer structure including a covering layer and a core layer.

### Advantageous Effects Of Invention

Since the gripping tool according to the disclosed technology has the above configuration, the operating tabs can be strongly pulled, and therefore this is more practical compared to the conventional gripping tool.

### BRIEF DESCRIPTION OF DRAWINGS

FIG. 1 is an explanatory diagram showing a flapping bird made from origami.

FIG. 2 is an explanatory diagram showing the features of a gripping tool 100 according to Embodiment 1.

FIG. 3 is a cross-sectional view taken along line A-A of FIG. 2.

FIG. 4 is an assembly diagram showing the attachment and detachment of a fingertips portion 150 of the gripping tool 100 according to Embodiment 1.

FIG. 5 is an isometric view showing the appearance of the gripping tool 100 according to Embodiment 1.

FIG. 6 is an isometric view showing the appearance of a gripping device according to Embodiment 1.

FIG. 7 is an isometric view showing the appearance of a gripping device according to Embodiment 2.

FIG. 8 is an explanatory diagram showing a mechanism by which a pull portion 130 is attached to or detached from an arm 200.

### DESCRIPTION OF EMBODIMENTS

### Embodiment 1

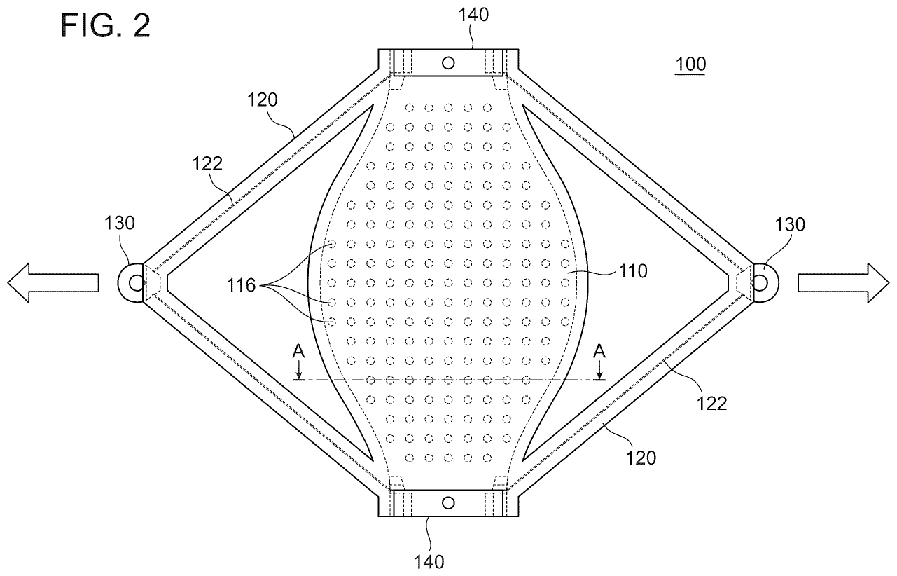

FIG. 2 is an explanatory diagram showing features of a gripping tool 100 according to Embodiment 1. As shown in FIG. 2, the gripping tool 100 according to Embodiment 1 includes a gripping portion 110, tendon portions 120, pull portions 130, and sockets 140. The tendon portions 120 each have a string portion 122 inside.

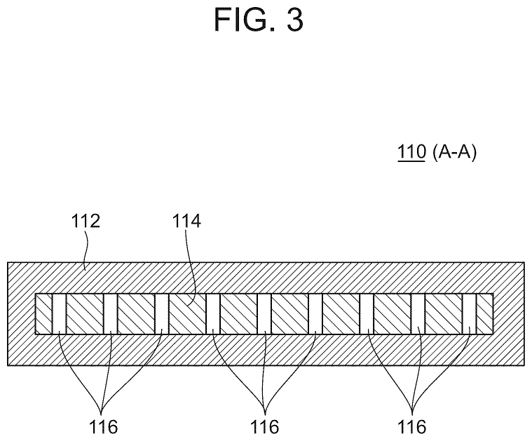

FIG. 3 is a cross-sectional view taken along line A-A of FIG. 2. As shown in FIG. 3, the gripping portion 110 included in the gripping tool 100 preferably has a two-layer structure, consisting of a covering layer 112 and a core layer 114. The core layer 114 may have a plurality of holes 116 as shown in FIGS. 2 and 3 to adjust the stiffness.

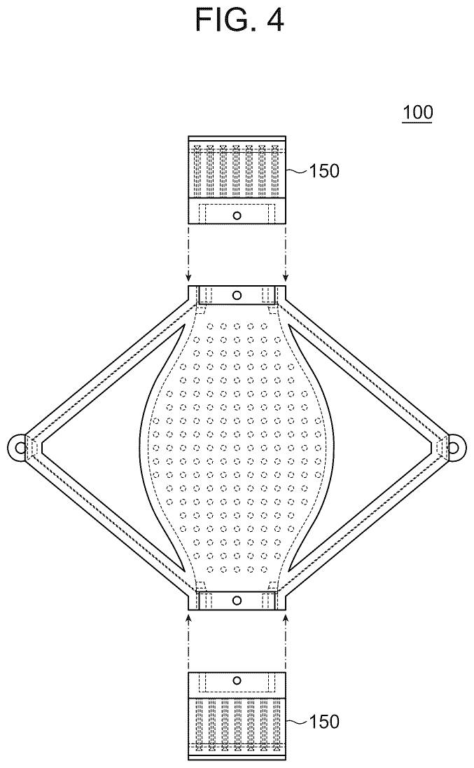

FIG. 4 is an assembly diagram showing the attachment and detachment of the fingertips portions 150 of the gripping tool 100 according to Embodiment 1. The fingertips portions 150 each are detachable at the socket 140 included in the gripping tool 100.

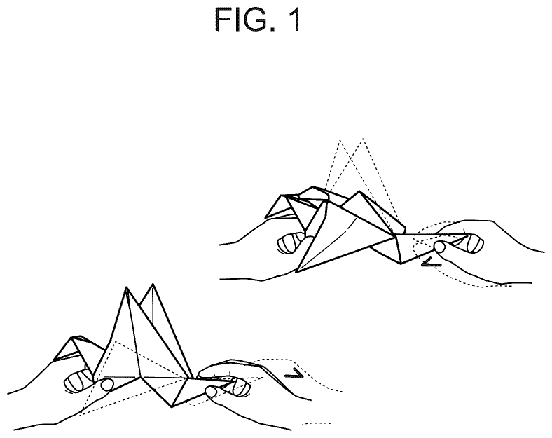

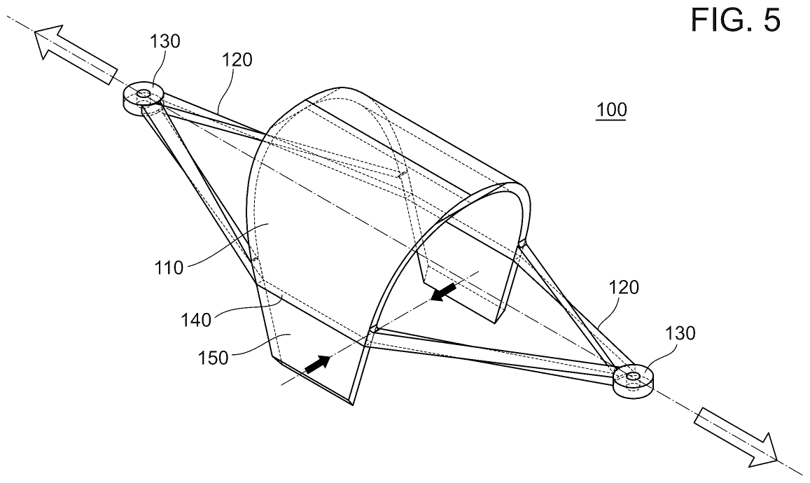

FIG. 5 is an isometric view showing the appearance of the gripping tool 100 according to Embodiment 1. Two black arrows shown in FIG. 5 represent directions in which the fingertips portions 150 move as if fingers were closing when the fingertips portions 150 grasp an object. This movement is achieved by pulling a pair of pull portions 130 in directions indicated by the white arrows, respectively. This driving principle is the same as the driving principle of the origami “flapping bird” shown in FIG. 1.

Overseas, the “flapping bird” made by origami is not well known. Another example based on the same principle is the pop-up book gimmick. Overseas, the pop-up book gimmick is sometimes referred to as a “kirigami”. In addition, kirigami is recognized as a type of origami, overseas. Therefore, this driving principle is referred to as the “a principle of driving kirigami”, hereinafter.

### (Gripping Portion 110 Included in Gripping Tool 100)

The gripping portion 110 included in the gripping tool 100 is a sheet-shaped component, the gripping portion 110 being used to cover a gripping target. To use a figurative expression, the gripping portion 110 is a component equivalent to the palm and the back of the human hand.

As described above, the gripping portion 110 included in the gripping tool 100 preferably has a two-layer structure consisting of the covering layer 112 and the core layer 114. The covering layer 112 may be made of a synthetic resin such as, for example, a silicone resin. In addition to silicone resin, the covering layer 112 can be made of a soft rubber-like material having friction, such as urethane rubber. The core layer 114 may be made of a synthetic resin such as, for example, PET (Polyethylene terephthalate). Such a gripping portion 110 having the two-layer structure can be manufactured by a modeling method in which resin is poured into a mold. In addition to PET, the core layer 114 may be made of a plastic material generated from plant-derived lactic acid, such as PLA resin. Since the core layer 114 is used to increase the rigidity that cannot be obtained by the coating layer 112 alone, a material suitable for increasing the rigidity is selected.

The gripping portion 110 needs to have, as a whole, the strength and properties to deform elastically without breaking so that the principle of the driving kirigami can be demonstrated.

### (Tendon Portion 120 Included in Gripping Tool 100)

The tendon portion 120 included in the gripping tool 100 is a component that transmits a force pulling the gripping portion 110 from both sides and is equivalent to the human tendon in a figurative expression. That is, it can be said that the gripping device having the gripping tool 100 according to the disclosed technology is a tendon driven robot.

The tendon portion 120 has a V shape as a default as shown in FIG. 2, and when a tensile force is applied, the angle forming the V shape decreases.

As described above, the tendon portion 120 has a structure that includes the string portion 122 inside. The string portion 122 may be made of, for example, a synthetic fiber or a chemical fiber such as a high-density polyethylene fiber.

The string portion 122 may be made of nylon tegus used as a fishing line. Furthermore, the string portion 122 may be made of a metal wire. The material of the tendon portion 120 covering the string portion 122 may be the same as that of the covering layer 112.

The tendon portion 120 needs to have, as a whole, the strength and properties that do not stretch or break so that the gripping portion 110 can be pulled from both sides.

### (Pull Portion 130 Included in Gripping Tool 100)

The pull portion 130 included in the gripping tool 100 is a component corresponding to the actuation tab described in Patent Document 1. From a functional point of view, the pull portion 130 included in the gripping tool 100 is a component that connects the tendon portion 120 and the arm 200, and the arm 200 will be described later. As shown in FIGS. 2 and 5, the pull portion 130 functions like a pulley and can pull the string portion 122. The pull portion 130 is provided with a shaft hole for attachment to the arm 200.

### (Socket 140 Included in Gripping Tool 100)

The socket 140 included in the gripping tool 100 is a component that connects the gripping portion 110 and the fingertips portion 150. The socket 140 enables the fingertips portion 150 to be attachable to and detachable from the gripping portion 110.

By providing the socket 140 and making the fingertips portion 150 detachable, it is possible to prepare a plurality of types of the fingertips portion 150 according to an assumed gripping target in advance, and at the time of operation, to select fingertips portion 150 having properties suitable for gripping the gripping target. In addition, by providing the socket 140 and making the fingertips portion 150 detachable, it has advantages of facilitating replacement needed for hygiene reasons and facilitating maintenance.

### (Fingertips Portion 150 Included in Gripping Tool 100)

The fingertips portions 150 included in the gripping tool 100 are components that come into direct contact with the gripping target and, in a figurative expression, are components equivalent to the human fingers. However, in FIGS. 2 to 7 explaining the disclosed technology, the fingertips of the fingertips portion 150 are not meant to move independently like the human fingers.

The fingertips portion 150 may be made using the same material as that of the gripping portion 110. Also, the fingertips portion 150 may have the same two-layer structure as the gripping portion 110. However, an advantageous effect of the gripping tool 100 according to the disclosed technology is that by making the fingertips portion 150 detachable, a material and structure suitable for gripping the gripping target can be adopted. Since the conventional gripping device shown in Patent Document 1 is overly focused on the concept of manufacturing from a single sheet of flexible material, there is the practical disadvantage that the rigidity of the part corresponding to the fingertip is not necessarily sufficient. A technical feature of the disclosed technology of providing the socket 140 and the fingertips portion 150 is a devise to overcome this practical problem.

It is important that the fingertips portion 150 have rigidity and friction that prevents the gripping target from sliding off when gripping. It is also important that the fingertips portion 150 is flexible so as not to damage the gripping target when gripping it.

As described above, it is conceivable that a plurality of types of the fingertips portion 150 is prepared according to the assumed gripping target. This idea is the same as the fact that tweezers with various tip shapes are prepared according to the purpose of use.

For example, if the gripping target is a plate-like target such as a substrate or a card, the fingertips portion 150 may have a shape in which the tip is thinned and slightly bent towards the inside in the gripping direction. By designing the fingertips portion 150 in a way described above, even a plate-like gripping target placed on a table can be grasped and lifted.

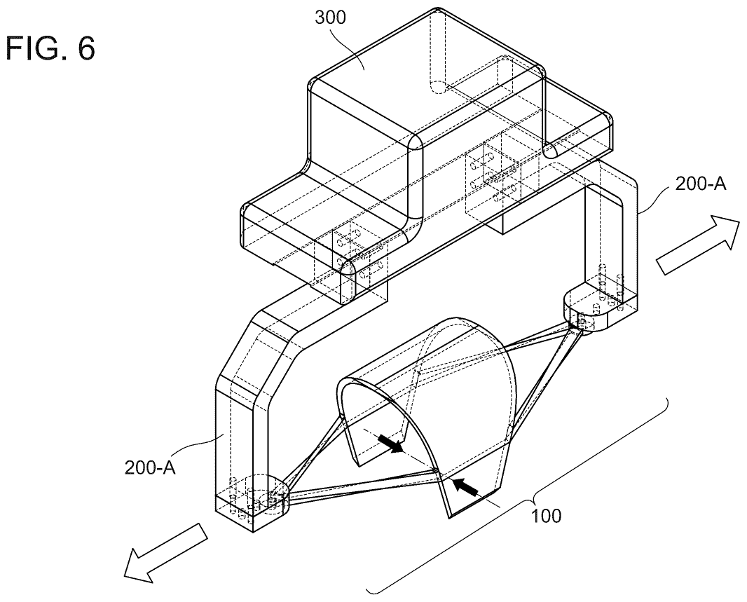

FIG. 6 is an isometric view showing the appearance of the gripping device according to Embodiment 1. As shown in FIG. 6, the gripping device according to Embodiment 1 includes the gripping tool 100, an arm 200-A, and an actuating portion 300.

### (Arm 200 Included in Gripping Device)

The arm 200 included in the gripping device is a component that serves to connect the gripping tool 100 and the actuating portion 300. As the name suggests, the arm 200 is, in a figurative expression, equivalent to a human arm. As shown in FIG. 6, when emphasizing that the arm 200 is an aspect in Embodiment 1, it is denoted as “arm 200-A” with “-A” appended after the reference numerals.

The arm 200-A has, for example, a shaft shape at the lower end (hereinafter referred to as “attachment shaft”), and by passing the attachment shaft through the shaft hole provided in the pull portion 130, the gripping tool 100 can be held.

As shown in FIG. 6, when the arms 200-A pull the pull portion 130 in the direction indicated by the white arrow, the arms 200-A is pulled in the direction opposite to the direction indicated by the white arrow due to the resilience of the gripping portion 110. The force based on the resilience of the gripping portion 110 holds the gripping tool 100. When the arm 200-A is driven in a direction opposite to the direction indicated by the white arrow and the string portion 122 is then loosened, the resilience of the gripping portion 110 is reduced. That is, the gripping device according to the disclosed technology can easily detach the gripping tool 100 from the arm 200-A just by driving the arm 200-A and by loosening the tension of the string portion 122.

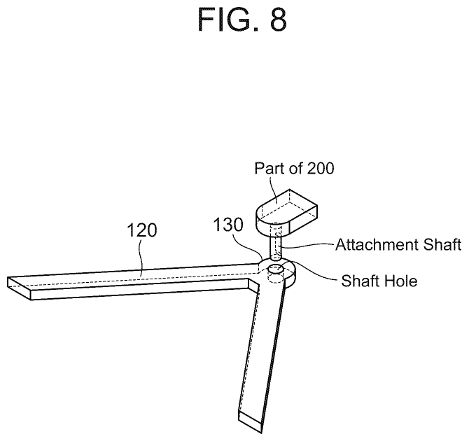

FIG. 8 is an explanatory diagram showing the mechanism by which the pull portion 130 is attached to or detached from the arm 200. As shown in FIG. 8, the arm 200 is provided with the attachment shaft, and the pull portion 130 is provided with the shaft hole. To make the detachment of the gripping tool 100 from the arm 200 easier, the diameter of the shaft hole should be larger than the diameter of the attachment shaft.

Furthermore, in the arm 200, the attachment shaft may be tapered or have steps to prevent the attachment shaft from coming out of the shaft hole especially when the gripping target is heavy.

### (Actuating Portion 300 Included in Gripping Device)

The actuating portion 300 that constitutes the gripping device is the component driving the arm 200. Specifically, the actuating portion 300 may be achieved by an electric slider. The electric slider has a motor, and a mechanism converting a rotational motion into a linear motion. Since the purpose of the actuating portion 300 is to achieve a linear motion, the actuating portion 300 may adopt a linear motor.

The gripping device needs to be controlled not only the opening and closing of the gripping tool 100, but also the position and orientation of the gripping tool 100 necessary for gripping the gripping target. FIG. 6 shows the actuating portion 300 that achieves opening and closing of the gripping tool 100 but does not show all configuration components necessary as a gripping device. It is not illustrated in FIG. 6, but the gripping device has a mechanism and a drive source for changing the position and orientation of the gripping tool 100.

An advantageous effect of the gripping tool 100 according to Embodiment 1 is that, since the gripping tool 100 includes the tendon portion 120 having the string portion 122 internally and the pull portion 130 that functions like a pulley, shear stress is not concentrated in the slot of the sheet, and therefore it is possible to strongly pull the pull portion 130 which is the actuation tab.

Another advantageous effect of the gripping tool 100 according to Embodiment 1 is that by making the fingertips portion 150 detachable, a material and structure suitable for gripping the gripping target can be selected, and the rigidity of the fingertips portion 150 necessary for gripping can be ensured.

An advantageous effect of the gripping device according to Embodiment 1 is that, since the pull portion 130 is provided with the shaft hole for attachment to the arm 200-A and the arm 200-A is provided with the attachment shaft, the gripping tool 100 can be easily detached from the arm 200-A by driving the arm 200-A in a direction that loosens the tension of the string portion 122.

Therefore, the gripping device according to the disclosed technology can provide a gripping tool 100 that is disposable together with the gripping object to be disposed of, for example, in a field that handles contaminated medical waste or radioactive substances and can contribute to automation.

As described above, the gripping tool 100 and the gripping device according to Embodiment 1 are practical compared to those related to the prior art.

### Embodiment 2

A gripping device according to Embodiment 2 is a modified version of the gripping device according to the disclosed technology.

Unless otherwise specified, in Embodiment 2, the same reference numerals as those in Embodiment 1 will be used. In Embodiment 2, the description overlapping with Embodiment 1 is omitted as appropriate.

When emphasizing that the arm 200 is an aspect in Embodiment 2, it is denoted as “arm 200-B” with “-B” appended after the reference numerals.

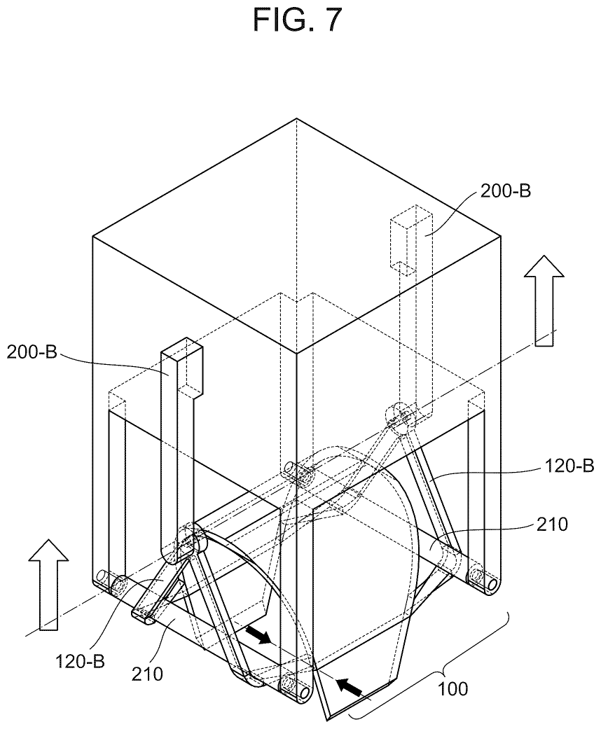

FIG. 7 is an isometric view showing the appearance of the gripping device according to Embodiment 2.

In the gripping device according to Embodiment 1 shown in FIG. 6, the fingertips portion 150 grips the gripping target by moving the arm 200-A in the horizontal direction indicated by the white arrows. Whereas, in the gripping device according to Embodiment 2 shown in FIG. 7, the fingertips portion 150 grips the gripping target by moving the arm 200-B in the vertical direction indicated by the white arrows. Conversion of the drive direction of the arm 200 from the horizontal to the vertical is enabled by two guide rollers 210, as shown in FIG. 7. From the perspective of the string portion 122, the guide roller 210 functions as a pulley in the same way as the pull portion 130.

An effect specific to the gripping device according to Embodiment 2 is that the occupying area of the device can be reduced compared to that of Embodiment 1 because the drive direction of the arm 200-B is converted to the vertical direction.

Another effect specific to the gripping device according to Embodiment 2 is that by providing the two guide rollers 210, the gripping tool 100 can avoid becoming an unstable state in which the gripping tool 100 rotates around the axis being pulled.

As described above, the gripping device according to Embodiment 2 is as practical as the gripping device according to Embodiment 1 compared to that in the prior art.

### Industrial Applicability

The gripping tool 100 and the gripping device according to the disclosed technology can be applied, for example, to robotic automation in the medical field and the food field, and therefore have industrial applicability.

In particular, the gripping device according to the disclosed technology can provide a disposable gripping tool 100, for example, in a field that handles contaminated medical waste or radioactive substances and can contribute to automation.

### REFERENCE SINGS LIST

100 gripping tool, 110 gripping portion, 112 covering layer, 114 core layer, 116 hole, 120 tendon portion, 122 string portion, 130 pull portion, 140 socket, 150 fingertips portion, 200 (200-A, 200-B) arm, 210 guide roller, 300 actuating portion.

1. A gripping tool to grip a gripping target on a basis of a principle of driving kirigami, the gripping tool comprising:
a gripping portion being sheet-shaped and configured to cover the gripping target;
tendon portions each having a string portion inside and transmitting a force pulling the gripping portion from both sides;
pull portions each being connected to the tendon portions and functioning as a pulley; and
fingertips portion each being attachable to and detachable from the gripping portion via a socket,
wherein the gripping portion has a two-layer structure including a covering layer and a core layer.

2. The gripping tool according to claim 1, wherein
the covering layer is made of silicone resin or urethane rubber, and
the core layer is made of plastic material.

3. A gripping device comprising:
the gripping tool according to claim 1; and
an arm connecting the gripping tool and an actuating portion,
wherein the actuating portion drives the arm in a direction in which the gripping tool is deformed by tension and the gripping target is grasped.

4. The gripping device according to claim 3, wherein
the arm has an attachment shaft,
the pull portions each have a shaft hole having a diameter larger than a diameter of the attachment shaft,
the gripping tool is held on the arm by passing the attachment shaft through the shaft hole, and
the gripping tool can be detached from the arm by driving the arm by the actuating portion so as to loosen the tension.

5. The gripping device according to claim 4, wherein
the attachment shaft is tapered or has steps.

6. The gripping device according to claim 4, wherein
the gripping tool is disposable together with the gripping target to be discarded.
